(19) United States
(12) Patent Application Publication
(10) Pub. No.: US 2023/0364814 A1
(43) Pub. Date: Nov. 16, 2023

(54) Universal Comb Fade Blade

(71) Applicant: Louis J. Wilkerson, National City, CA (US)

(72) Inventor: Louis J. Wilkerson, National City, CA (US)

(21) Appl. No.: 18/317,763

(22) Filed: May 15, 2023

Related U.S. Application Data
(60) Provisional application No. 63/354,572, filed on Jun. 22, 2022.
(60) Provisional application No. 63/341,527, filed on May 13, 2022.

(51) Int. Cl. B26B 19/20; B26B 19/22; B26B 19/38

(52) U.S. Cl. CPC B26B 19/20; B26B 19/22; B26B 19/3813

(57) ABSTRACT

The present invention is a universal comb fade blade that has a cutting blade and a comb blade. The cutting blade has a clipper mount, a plurality of cutting blade holes and cutting blade teeth. The cutting blade is made of metal or ceramic material. The comb blade has screw holes and comb blade teeth. The screw holes allow the present invention to attach to any external hair clipper device. The cutting blade is positioned offset above the comb blade allowing the two to create a scissor motion cutting hair follicles in between the two. The cutting blade facilitates back and forth movement along the comb blade. The clipper mount secures the clipper blade to an external hair clipper device and does not interfere with the hair being cut, allowing the present invention to attach to any external hair clipper device.

### FIELD OF THE INVENTION

The present invention relates generally to a hair clipper fading blade. More specifically, the present invention is a device that provides a hair clipper attachment that decreases in size along the length, allowing for the present invention to make different length fades when cutting various hairstyles.

### BACKGROUND OF THE INVENTION

Every clipper has two blades for cutting hair, a cutter, and a comb. Clipper blades are the part of a clipper where two blades are aligned with each other, the larger bottom blade, the comb, which feeds the hair into the top for cutting, called the cutting blade 1. The cutting blade 1 is moved back and forth at high speeds by the clipper motor while the comb blade 2 stays stationary. Blades are made of metallic materials in a single layer. Clipper blades are secured to the clipper where the bottom comb is stationary, and the cutter blade is free to oscillate back and forth by a motor. There are different sizes of comb blade 2 that are used to cut different lengths of hair. Some clippers have quick release blades to switch between different sizes while others are secured to the clipper with two screws.

An objective of the present invention is to provide users with a universal fade comb blade 2, to help create fades of varying levels and tappers. The present invention intends to provide users with a device that can attach to any type of standard hair clipper. In order to accomplish that, a preferred embodiment of the present invention comprises a cutting blade 1 and a comb blade 2. Further, the clipper mount 11 allows the present invention to easily attach to any standard hair clipper device. Thus, the present invention is a universal comb fade blade with tapered teeth blades that can easily attach to any hair clipper and create fades of varying levels and tappers.

### BRIEF DESCRIPTION OF THE DRAWINGS

FIG. 1 is a bottom left perspective view of the comb blade.

FIG. 2 is a top right perspective view of the comb blade.

FIG. 3 is a top view of the comb blade.

FIG. 4 is a bottom view of the comb blade.

FIG. 5 is a right-side view of the comb blade.

FIG. 6 is a rear top right perspective view of the cutting blade.

FIG. 7 is a bottom rear left perspective view of the cutting blade.

FIG. 8 is a top view of the cutting blade.

FIG. 9 is a bottom view of the cutting blade.

FIG. 10 is a front view of the cutting blade.

FIG. 11 is a right-side view of the cutting blade.

FIG. 12 is a top right perspective view of the present invention.

FIG. 13 is an illustration of the present invention attached to a hair clipper device being used on a human head.

### DETAIL DESCRIPTIONS OF THE INVENTION

All illustrations of the drawings are for the purpose of describing selected versions of the present invention and are not intended to limit the scope of the present invention.

The present invention, in its' preferred embodiment, relates to a clipper comb blade 2 that consists of two joined blades of numerous teeth with a tapered end that gradually gets larger from a minimum size to a larger size to accomplish a fade. The present invention describes a universal comb fade blade that makes it possible to fade without guards and any experience of fading techniques. The universal comb fade blade will shorten fading time it takes to create a fade and give barbers more income per hour. The fade blade will also allow non-experienced barbers and non-barbers to be able to create a perfect fade in less time. In the embodiment, the present invention relates to a universal fade comb blade 2, which is designed primarily for creating fades for all levels of fades and tappers. In the embodiment, the universal fade comb blade 2 can be used to replace the bottom comb blade 2 in majority of clipper brands due to the universal holes on the universal fade comb blade 2. In the embodiment, the universal comb fade blade is used for fading at different levels which generic blades cannot accomplish without a fading guard or a fading technique. Thus, the present invention is a universal comb fade blade with tapered teeth blades that can easily attach to any hair clipper and create fades of varying levels and tappers.

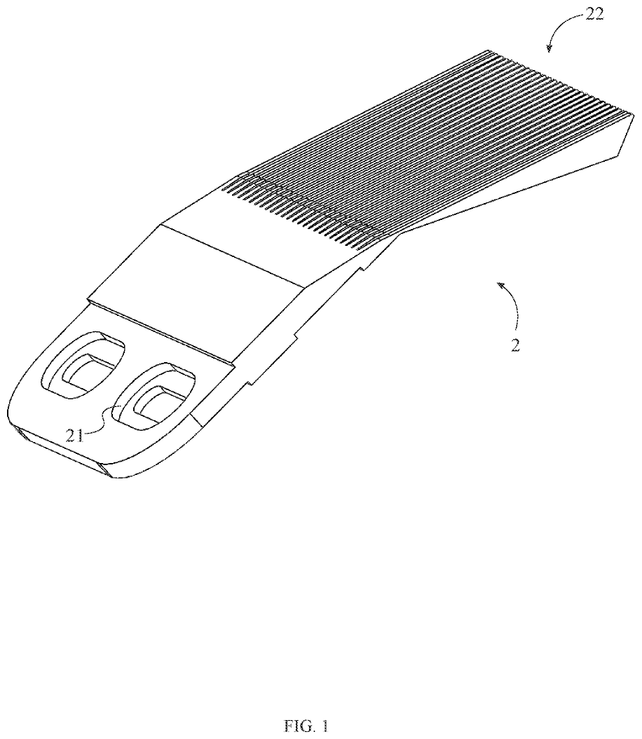

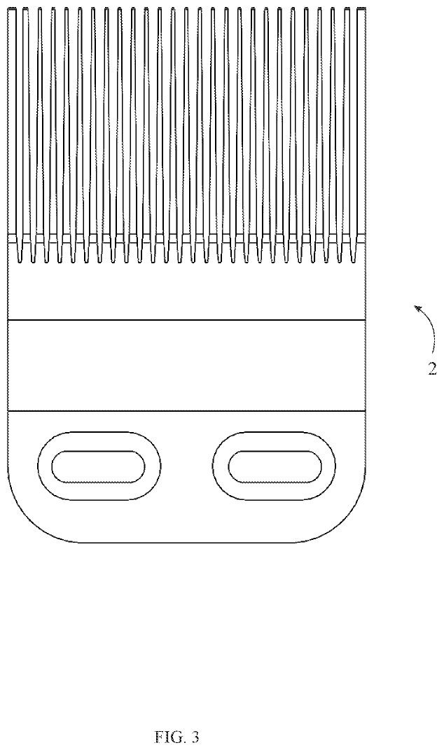

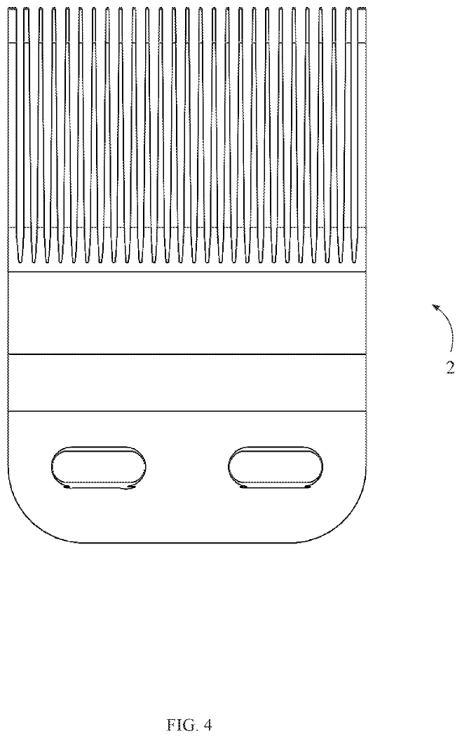

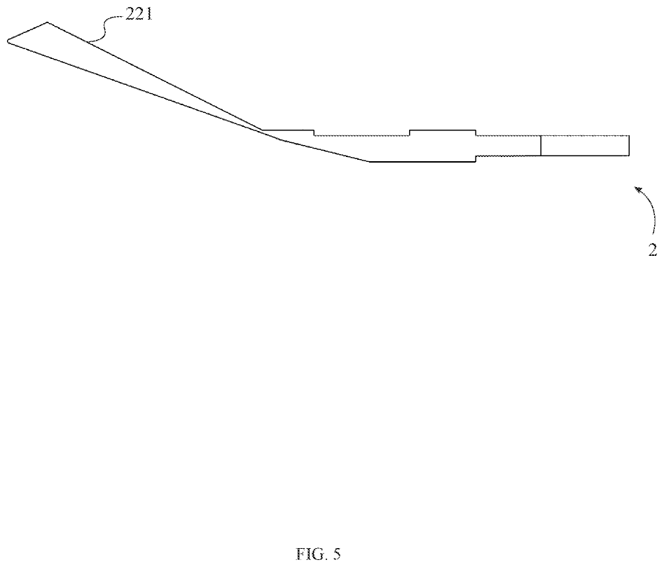

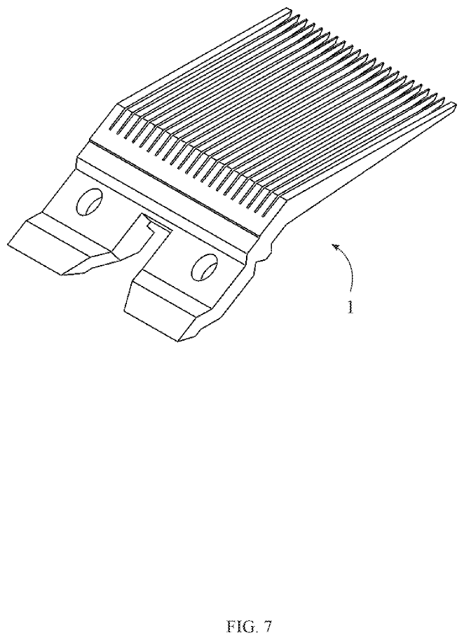

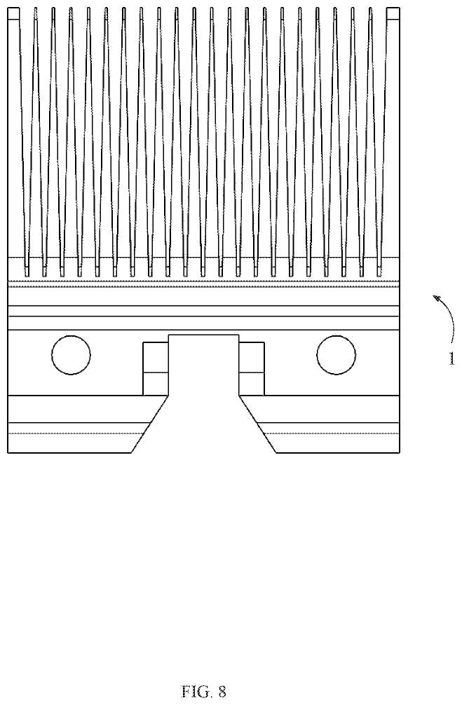

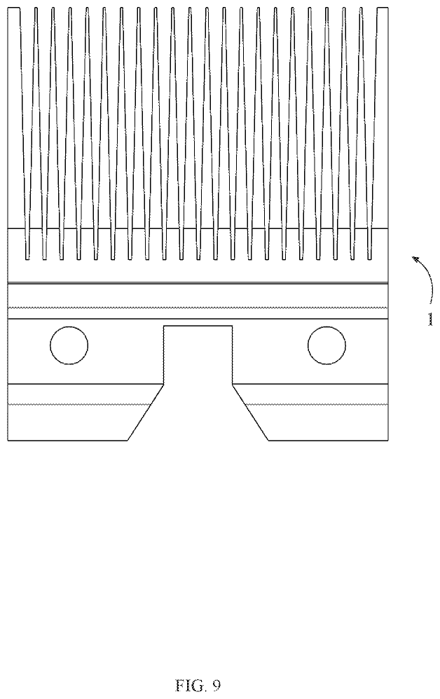

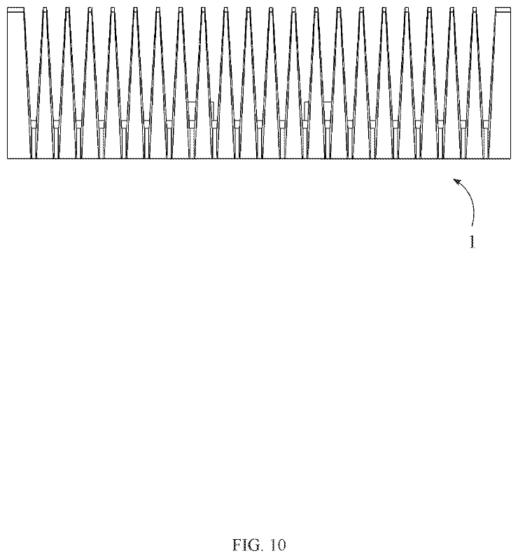

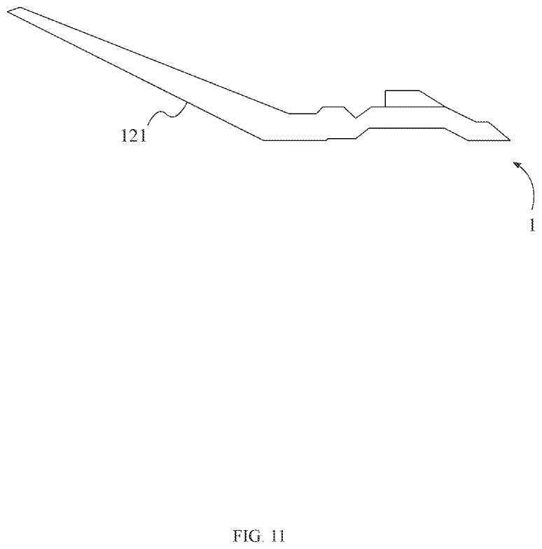

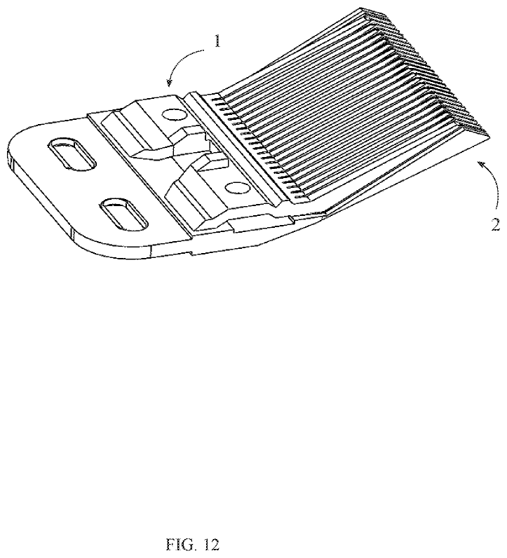

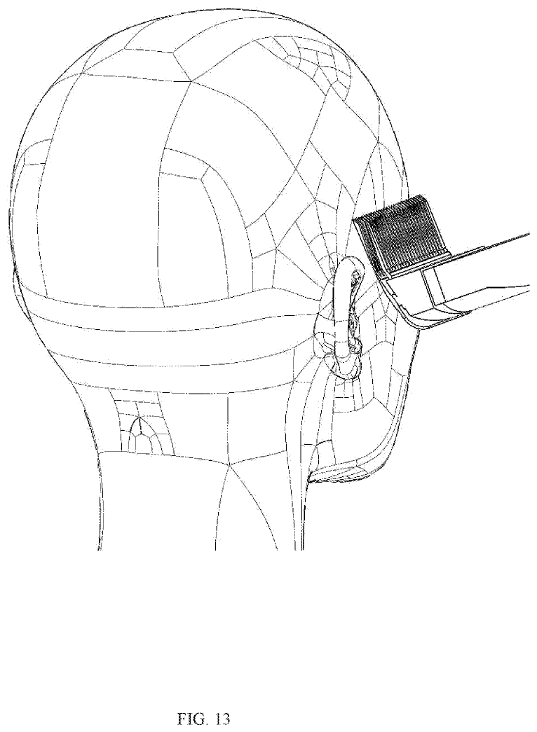

In reference to FIG. 1-13, the present invention is a universal comb fade blade that comprises a cutting blade 1 and a comb blade 2. The cutting blade 1 comprises a clipper mount 11, a plurality of cutting blade holes 13 and a plurality of cutting blade teeth 12. The cutting blade 1 is made of a material selected from a group consisting of metal or ceramics. The comb blade 2 comprises a plurality of screw holes 21 and a plurality of comb blade teeth 22. The plurality of screw holes 21 allows the present invention to attach to an external hair clipper device. The cutting blade 1 is positioned offset above the comb blade 2. Accordingly, the cutting blade 1 is parallel to the comb blade 2. The cutting blade 1 facilitates back and forth movement along the comb blade 2. Consequently, the cutting blade 1 cuts hair as it moves back and forth slightly above the comb blade 2. The clipper mount 11 is positioned along the rear side of the cutting blade 1. As a result, the clipper mount 11 secures the clipper blade to an external hair clipper device and does not interfere with the hair being cut. The clipper mount 11 receives an external hair clipper device. Thus, the present invention attaches to any external hair clipper device.

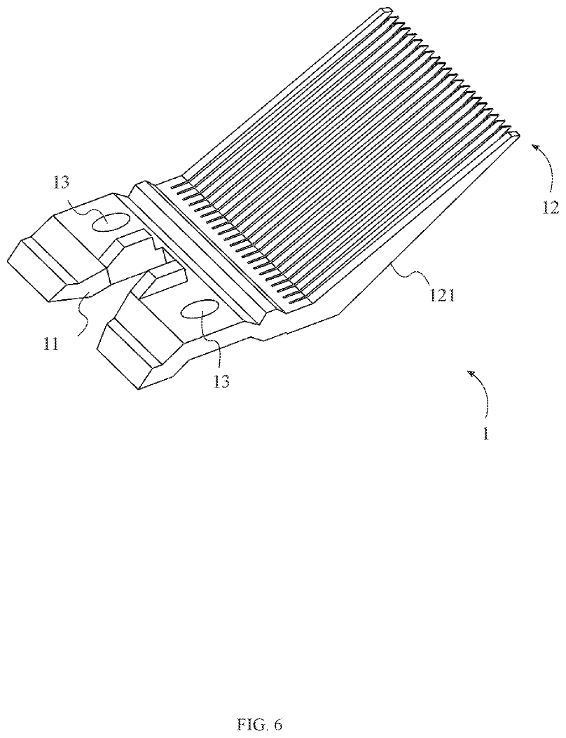

In reference to FIG. 6, the plurality of cutting blade teeth 12 is positioned along the front side of the cutting blade 1. So, the plurality of cutting blade teeth 12 does not interfere with the clipper mount 11. The plurality of cutting blade teeth 12 extends at an angle upwards and forwards. Accordingly, the plurality of cutting blade teeth 12 extend away from the external hair clipper device in a direction ensuring a faded hair style can be cut. The plurality of cutting blade teeth 12 is tapered at the front end of the cutting blade teeth 12. Consequently, the front thickness of the plurality of cutting blade teeth 12 is smaller as it extends forwards and upwards. The plurality of cutting blade teeth 12 has a gap in between each of the cutting blade teeth 12. As a result, hair can extend through each gap in between the cutting blade teeth 12, which allows the hair to be cut.

Further, the plurality of cutting blade teeth 12 comprises a cutting blade edge 121 as shown in FIG. 6. The cutting blade edge 121 is the portion of the cutting blade teeth 12 that cuts through the hair. The cutting blade edge 121 runs along the bottom length of the plurality of cutting blade teeth 12. Thus, the cutting blade edge 121 covers the entirety of the length of the cutting blade teeth 12. The cutting blade edge 121 is a sharp edge. So, the cutting blade edge 121 is designed to cut hair cleanly with ease.

In reference to FIG. 6, the plurality of cutting blade holes 13 is positioned along the rear side of the cutting blade 1. Accordingly, the plurality of cutting blade holes 13 is not located near the plurality of cutting blade teeth 12. The plurality of cutting blade holes 13 traverses through the cutting blade 1. Consequently, the plurality of cutting blade holes 13 receives any external attachments. The plurality of cutting blade holes 13 is positioned on either side of the clipper mount 11. As a result, the plurality of cutting blade holes 13 does not interfere with the clipper mount 11.

In reference to FIG. 1, the plurality of screw holes 21 is positioned along the rear side of the comb blade 2. Thus, the plurality of screw holes 21 is positioned away from the plurality of comb blade teeth 22. The plurality of screw holes 21 receives a plurality of external screws from the hair clipper device. So, the plurality of screw holes 21 allows the comb blade 2 to be secured to an external hair clipper device. The plurality of screw holes 21 traverses through the comb blade 2. Accordingly, the plurality of screw holes 21 creates an open-ended hole on the comb blade 2. The plurality of screw holes 21 has a rectangular shape with two curved ends. Consequently, the plurality of screw holes 21 receives external screw with various spacing widths.

In reference to FIG. 1, the plurality of comb blade teeth 22 is positioned along the front side of the comb blade 2. As a result, the plurality of comb blade teeth 22 easily contacts the hair follicles being cut. The plurality of comb blade teeth 22 extends at an angle upwards and forwards from the comb blade 2. Thus, the plurality of comb blade teeth 22 allows for gradual fading against the grain of the hair follicle. The plurality of comb blade teeth 22 has a gap in between each of the plurality of comb blade teeth 22. So, the plurality of comb blade teeth 22 allows for a hair follicle to pass in between through the gap. The plurality of comb blade teeth 22 is tapered outwards at the front end of the comb blade 2. Accordingly, the plurality of comb blade teeth 22 creates a scalene triangle shape.

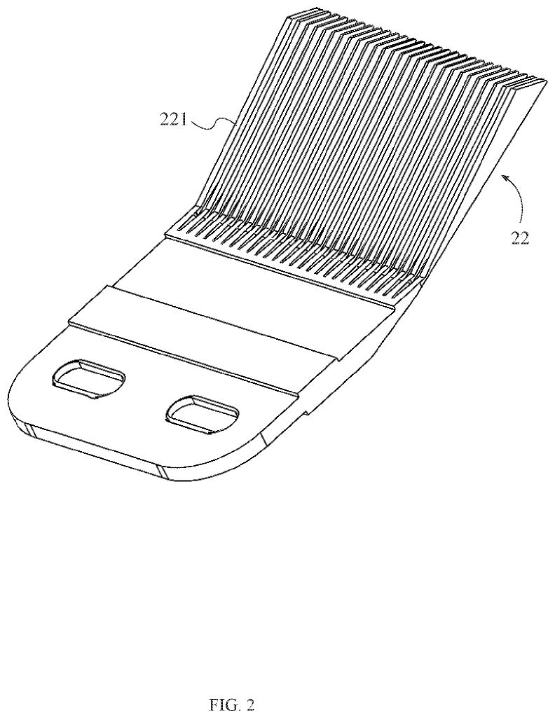

Furthermore, the plurality of comb blade teeth 22 comprises a comb blade edge 221 as shown in FIG. 2. The comb blade edge 221 is positioned along a top side of the plurality of comb blade teeth 22. Consequently, the comb blade edge 221 creates a scissor cutting action against the cutting blade edge 121 positioned above the comb blade edge 221. The comb blade edge 221 is flush with a cutting blade edge 121. As a result, a clean cut is created by the comb blade edge 221 and the cutting blade edge 121.

Although the invention has been explained in relation to its preferred embodiment, it is to be understood that many other possible modifications and variations can be made without departing from the spirit and scope of the invention as hereinafter claimed.

What is claimed is:

1. A Universal Comb Fade Blade comprising:
a cutting blade;
a comb blade:
the cutting blade comprising a clipper mount, a plurality of cutting blade holes and a plurality of cutting blade teeth;
the comb blade comprising a plurality of screw holes and a plurality of comb blade teeth;
the cutting blade being positioned offset above the comb blade;
the cutting blade facilitating back and forth movement along the comb blade;

2. The Universal Comb Fade Blade as claimed in claim 1 comprising:
the clipper mount being positioned along the rear side of the cutting blade;
the clipper mount receiving an external hair clipper device;

3. The Universal Comb Fade Blade as claimed in claim 1 comprising:
the plurality of cutting blade teeth being positioned along the front side of the cutting blade;
the plurality of cutting blade teeth extending at an angle upwards and forwards;
the plurality of cutting blade teeth being tapered at a front end of the cutting blade teeth;
the plurality of cutting blade teeth having a gap in between each of the cutting blade teeth;

4. The Universal Comb Fade Blade as claimed in claim 2 comprising:
the plurality of cutting blade teeth comprising a cutting blade edge;
the cutting blade edge running along the bottom length of the plurality of cutting blade teeth;
the cutting blade edge being a sharp edge;

5. The Universal Comb Fade Blade as claimed in claim 1 comprising:
the plurality of cutting blade holes being positioned along the rear side of the cutting blade;
the plurality of cutting blade holes traversing through the cutting blade;
the plurality of cutting blade holes being positioned on either side of the clipper mount;

6. The Universal Comb Fade Blade as claimed in claim 1 comprising:
the plurality of screw holes being positioned along the rear side of the comb blade;
the plurality of screw holes receiving a plurality of external screws from the hair clipper device;
the plurality of screw holes traversing through the comb blade;
the plurality of screw holes having a rectangular shape with two curved ends;

7. The Universal Comb Fade Blade as claimed in claim 1 comprising:
the plurality of comb blade teeth being positioned along the front side of the comb blade;
the plurality of comb blade teeth extending at an angle upwards and forwards from the comb blade;
the plurality of comb blade teeth having a gap in between each of the plurality of comb blade teeth;
the plurality of comb blade teeth being tapered outwards at a front end of the comb blade;

8. The Universal Comb Fade Blade as claimed in claim 7 comprising:
the plurality of comb blade teeth comprising a comb blade edge;
the comb blade edge being positioned along a top side of the plurality of comb blade teeth;

9. The Universal Comb Fade Blade as claimed in claim 8 comprising the comb blade edge being flush with a cutting blade edge;

10. A Universal Comb Fade Blade comprising:
a cutting blade;
a comb blade:
the cutting blade comprising a clipper mount, a plurality of cutting blade holes and a plurality of cutting blade teeth;
the comb blade comprising a plurality of screw holes and a plurality of comb blade teeth;
the cutting blade being positioned offset above the comb blade;
the cutting blade facilitating back and forth movement along the comb blade;

11. The Universal Comb Fade Blade as claimed in claim 10 comprising:
the clipper mount being positioned along the rear side of the cutting blade;
the clipper mount receiving an external hair clipper device;

12. The Universal Comb Fade Blade as claimed in claim 10 comprising:
the plurality of cutting blade teeth being positioned along the front side of the cutting blade;
the plurality of cutting blade teeth extending at an angle upwards and forwards;
the plurality of cutting blade teeth being tapered at a front end of the cutting blade teeth;
the plurality of cutting blade teeth having a gap in between each of the cutting blade teeth;
the plurality of cutting blade teeth comprising a cutting blade edge;
the cutting blade edge running along the bottom length of the plurality of cutting blade teeth;
the cutting blade edge being a sharp edge;

13. The Universal Comb Fade Blade as claimed in claim 10 comprising:
the plurality of cutting blade holes being positioned along the rear side of the cutting blade;
the plurality of cutting blade holes traversing through the cutting blade;
the plurality of cutting blade holes being positioned on either side of the clipper mount;

14. The Universal Comb Fade Blade as claimed in claim 10 comprising:
the plurality of screw holes being positioned along the rear side of the comb blade;
the plurality of screw holes receiving a plurality of external screws from the hair clipper device;
the plurality of screw holes traversing through the comb blade;
the plurality of screw holes having a rectangular shape with two curved ends;

15. The Universal Comb Fade Blade as claimed in claim 10 comprising:
the plurality of comb blade teeth being positioned along the front side of the comb blade;
the plurality of comb blade teeth extending at an angle upwards and forwards from the comb blade;
the plurality of comb blade teeth having a gap in between each of the plurality of comb blade teeth;
the plurality of comb blade teeth being tapered outwards at a front end of the comb blade;

16. The Universal Comb Fade Blade as claimed in claim 15 comprising:
the plurality of comb blade teeth comprising a comb blade edge;
the comb blade edge being positioned along a top side of the plurality of comb blade teeth;
the comb blade edge being flush with a cutting blade edge;

17. A Universal Comb Fade Blade comprising:
a cutting blade;
a comb blade:
the cutting blade comprising a clipper mount, a plurality of cutting blade holes and a plurality of cutting blade teeth;
the comb blade comprising a plurality of screw holes and a plurality of comb blade teeth;
the cutting blade being positioned offset above the comb blade;
the cutting blade facilitating back and forth movement along the comb blade;
the clipper mount being positioned along the rear side of the cutting blade;
the clipper mount receiving an external hair clipper device;
the plurality of cutting blade teeth being positioned along the front side of the cutting blade;
the plurality of cutting blade teeth extending at an angle upwards and forwards;
the plurality of cutting blade teeth being tapered at a front end of the cutting blade teeth;
the plurality of cutting blade teeth having a gap in between each of the cutting blade teeth;
the plurality of cutting blade teeth comprising a cutting blade edge;
the cutting blade edge running along the bottom length of the plurality of cutting blade teeth;
the cutting blade edge being a sharp edge;

18. The Universal Comb Fade Blade as claimed in claim 17 comprising:
the plurality of cutting blade holes being positioned along the rear side of the cutting blade;
the plurality of cutting blade holes traversing through the cutting blade;
the plurality of cutting blade holes being positioned on either side of the clipper mount;

19. The Universal Comb Fade Blade as claimed in claim 17 comprising:
the plurality of screw holes being positioned along the rear side of the comb blade;
the plurality of screw holes receiving a plurality of external screws from the hair clipper device;
the plurality of screw holes traversing through the comb blade;
the plurality of screw holes having a rectangular shape with two curved ends;

20. The Universal Comb Fade Blade as claimed in claim 17 comprising:
the plurality of comb blade teeth being positioned along the front side of the comb blade;
the plurality of comb blade teeth extending at an angle upwards and forwards from the comb blade;
the plurality of comb blade teeth having a gap in between each of the plurality of comb blade teeth;
the plurality of comb blade teeth being tapered outwards at a front end of the comb blade;
the plurality of comb blade teeth comprising a comb blade edge;
the comb blade edge being positioned along a top side of the plurality of comb blade teeth;
the comb blade edge being flush with a cutting blade edge;
